(19) United States
(12) Patent Application Publication
(10) Pub. No.: US 2008/0037246 A1
(43) Pub. Date: Feb. 14, 2008

(54) Reusable Light Bar

(76) Inventor: Donald W. Schuettenberg, Antioch, IL (US)

Correspondence Address: VORYS SATER SEYMOUR PEASE, 1828 L STREET NW, ELEVENTH FLOOR, WASHINGTON, DC, 20036, US

(21) Appl. No.: 11/463,407

(22) Filed: Aug. 9, 2006

(51) Int. Cl. F21S 4/00

(52) U.S. Cl. 362/219

(57) ABSTRACT

A reusable, folding light bar is disclosed. The reusable light bar is made in three sections, a central section and two pivotally mounted side sections. The light bar mounts all the lights needed for the rear of a towed vehicle, such as a truck in transit. The light bar includes sockets and lights for left and right turn signals, brake lights, and rear and side clearance lights. There is also a connector for connecting to a source of power and control from the towing or towed vehicle, to operate the lights during transit. Protective enclosures, such as wire cages, may be included for at least the side clearance lights. After a tow operation is complete, the light bar in its operational extended configuration is folded into its folded configuration for transport back to an owner or lessee of the light bar.

### FIELD OF THE INVENTION

This invention generally relates to towed motor vehicle transportation and a light bar to assist towing of vehicles from one location to another location.

### BACKGROUND OF THE INVENTION

The economy of the United States, if not of the world, depends to a great extent on fleets of large trucks for the distribution of goods, such as foods, consumer products, durable goods, and even industrial equipment. There are many manufacturers of such trucks, which concern primarily, but are not limited to, class 7 or class 8 over-the-road trucks. Once these trucks are manufactured, they require shipment or transportation either to the carrier or other company for whom the truck was made, or to a dealer who sells or leases these trucks. The most obvious method to transport these trucks is by driving them directly to their destination. This method has disadvantages, at least because each truck requires a driver, who must be paid for his or her services and for whom return transportation must be arranged.

In order to overcome the necessity of a driver for delivering each truck, a variety of techniques have been devised to use a first truck that will carry or tow one or more additional trucks to the desired destination. When a truck is towed, however, provision must be made for illuminating lights on the rear and sides of the towed vehicle, in order to ensure the safety of the vehicles, and also to comply with traffic rules and regulations. One method of accomplishing this uses a light bar made from a metallic structural member, such a channel having a C-shaped cross-section, or an I-beam. The channel or I-beam is preferably made from aluminum or an aluminum alloy whose length is about as long as the expected width of the towed vehicle. Steel shapes may also be used, but they are much heavier and more difficult to maneuver into place. The channel is equipped with the necessary sockets and lights and is affixed to the rear of the towed vehicle. One problem with this technique is that the light bar tends to be heavy if it is made from steel. Because of its length, as much as 7 or 8 feet long, special arrangements may have to be made for its return to the owner or lessee for another use. One such light bar is disclosed in U.S. Pat. No. 4,493,491.

A similar light bar is disclosed in U.S. Pat. No. 4,974,125, for a vehicular light bar arrangement. The light bar disclosed herein may also be the full width of the vehicle on which it is used. A reusable emergency vehicle wiring harness and control system is disclosed in U.S. Pat. No. 5,703,411. This patent also discloses a full-width light bar, particularly for emergency vehicles. that includes wiring harnesses and connectors so that it may be disconnected and used in another vehicle without having to completely re-wire the light bar.

Another technique is disclosed in U.S. Pat. No. 6,847,863. This patent discloses a light bar on a towed vehicle, the light bar controlled by a radio receiver on the towed vehicle and in communication with the light bar, and a radio transmitter on the towing vehicle. There is virtually no description of the light bar, but it is clear that electro-magnetic interferences could develop between the vehicles and prevent or alter the transmission of signals between them.

Embodiments of the invention provide a better light bar for use on towed vehicles. These and other advantages, as well as additional inventive features, will be apparent from the description provided herein.

### BRIEF SUMMARY OF THE INVENTION

One embodiment is a reusable light bar. The reusable light bar includes a central portion configured for mounting a first plurality of lights, a left portion, pivotally connected to the central portion, the left portion configured for mounting a second plurality of lights, and a right portion, pivotally connected to the central potion, the right portion configured for mounting a third plurality of lights. The reusable light bar also includes at least one connector for connecting a source of electrical power to the first, second, and third pluralities of lights, wherein the reusable light bar has an extended configuration for use and a folded configuration for storage and transport.

Another embodiment is a reusable light bar. The reusable light bar includes a first portion comprising a first plurality of sockets, and optionally, a first plurality of lights mounted in the first plurality of sockets, a second portion pivotally connected to the first portion, the second portion comprising a second plurality of sockets, and optionally, a second plurality of lights mounted in the second plurality of sockets, and optionally, a third portion pivotally connected to the second portion, the third portion comprising a third plurality of sockets, and optionally, a third plurality of lights mounted in the third plurality of sockets, at least one connector mounted to one of the first and second portions; and a wiring harness connecting the at least one connector to each of the first and second pluralities of sockets, and optionally, to each of the third plurality of sockets.

Another embodiment provides a method for using a folding light bar. The method includes steps of providing a folding light bar in a folded or an extended configuration; if the light bar is in the folded configuration, unfolding the folding light bar and locking the folding light bar into the extended configuration; mounting the light bar onto a rear of a towed vehicle; and connecting the folding light bar to a source of electrical power.

Other aspects and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several embodiments of the present invention and, together with the description, serve to explain the principles of the invention. In the drawings:

FIG. 1 is a front view of a first embodiment of a reusable light bar;

FIG. 2 is a top view of the embodiment of FIG. 1;

FIG. 3 is a rear view of the embodiment of FIG. 1;

FIG. 4 is a view of the embodiment of FIG. 1 in a folded configuration;

FIG. 5 is a schematic view of a wiring diagram for a reusable light bar;

FIGS. 6 and 7 depict ways to secure the portable light bar to the rear of a vehicle being towed.

FIG. 8 depicts a side view of a towing vehicle with a second vehicle in tow using a light bar embodiment;

FIGS. 8a, 8b, and 8c depict pivoting mechanisms for the reusable light bar;

FIG. 9 depicts an alternate pivoting mechanism for a reusable light bar;

FIGS. 10a and 10b depict end views of left portions of the light bar; and

FIGS. 11-12 depict additional ways to secure the light bar portions in both the folded and extended configurations.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE PRESENTLY PREFERRED EMBODIMENTS OF THE INVENTION

Embodiments of the present invention are highly useful in transporting trucks and other vehicles, including new trucks, from one location to another. While embodiments are most useful in this application, they may also be used to transport other vehicles, such as used cars or trucks, from one dealer to another. The reusable, foldable light bar adds a measure of economy to towing operations, while also ensuring safety.

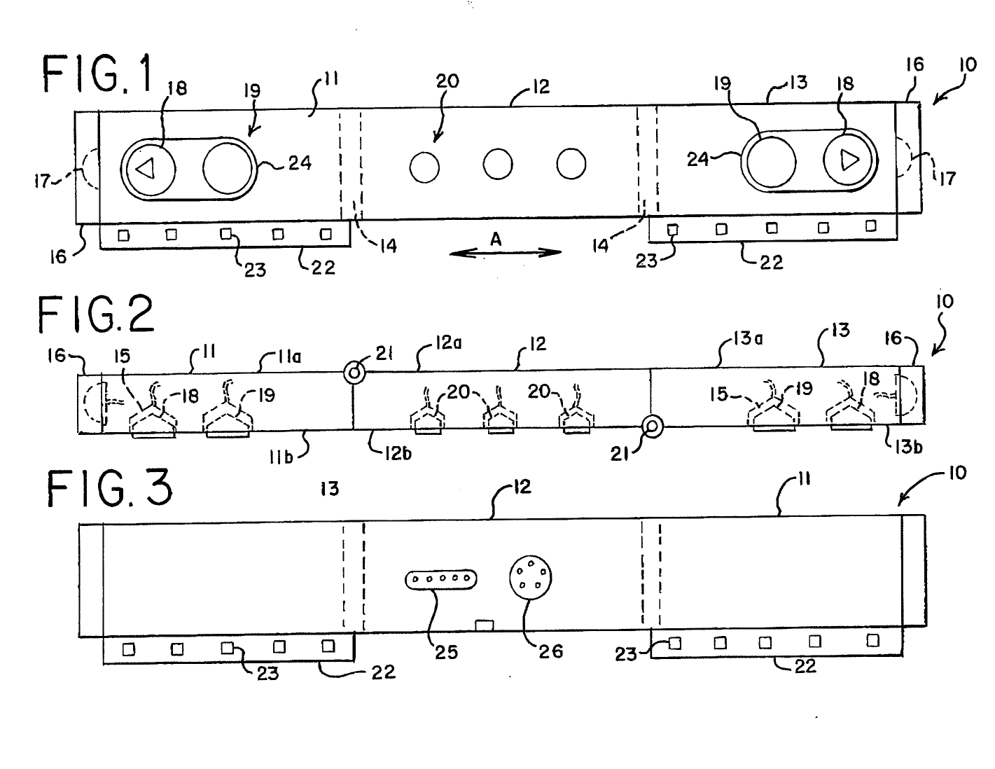

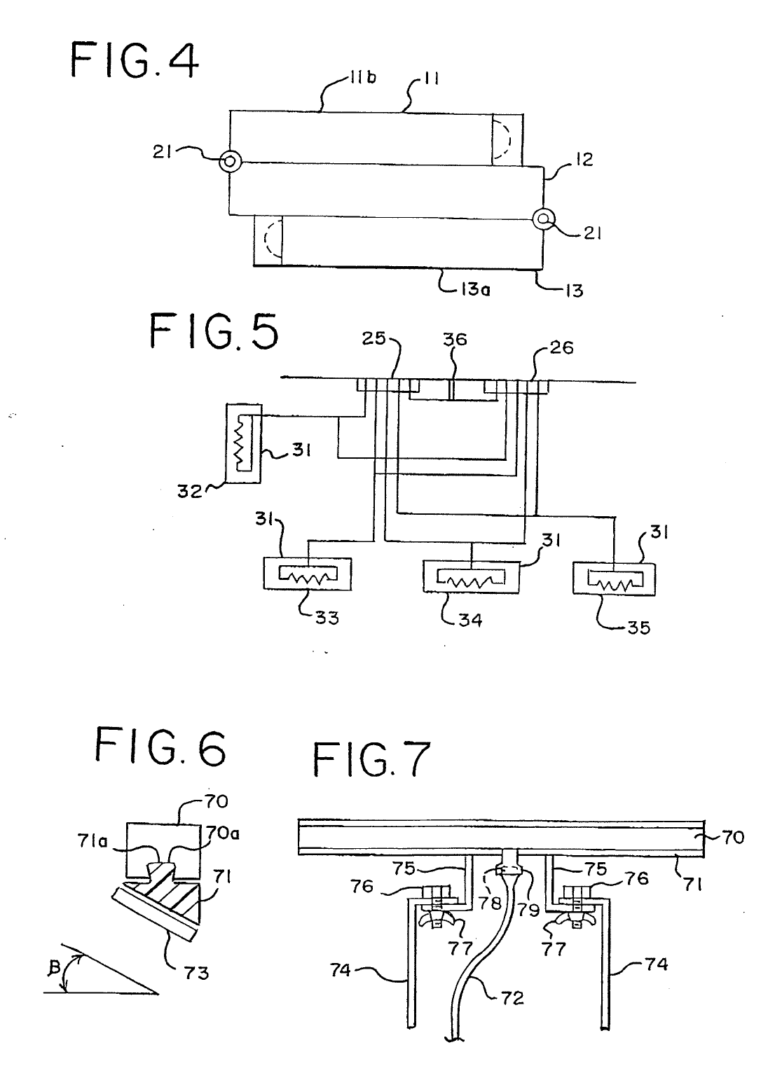

FIGS. 1-2 depict front and top views, respectively, of a first embodiment of a reusable light bar 10. FIGS. 1-2 depict the light bar in an extended configuration ready for use. Reusable light bar 10 preferably includes a left portion 11, a central portion 12, and a right portion 13. Left and right portions 11, 13 are connected to the central portion 12 by pivot pins 14 set into flanges or ears 21 that are formed into the sections. As shown especially in FIG. 2, one pivot is placed on a rear of the light bar and the other pivot is placed on the front of the light bar. To fold the light bar into a folded configuration, as depicted in FIG. 4, both pivots are moved clock-wise. The rear face 11a of left portion 11 moves near the rear face 12a of middle portion 12, and the front face 13b of right portion 13 moves near the front face 12b of middle portion 12. When light bar 10 is folded, front face 11b of the left portion and rear face 13a of the right portion are on the outside of the bar. Thus, the light bar is folded into a compact configuration of about one-third the length of the extended configuration.

Light bar 10 is configured to display a plurality of lights, also known as lamps, on each section or portion of the light bar. For example, left portion 11 may include a turn signal light 18 and a brake light 19, preferably housed within a lens 24. These lights are mounted so that they face at about 180°, i.e., transversely, to a longitudinal (left-right) axis A of the reusable light bar, said axis also being the longitudinal axis of each of the left, central, and right portions. Left portion 11 may also include a side clearance light 17 within a protective enclosure 16. Side clearance light 17 faces along the general direction of the longitudinal axis of the reusable light bar. The protective enclosure 16 may be a wire cage, or may be a translucent or colored and relatively transparent glass or plastic protective cover. The lights on the side of the truck are subject to more impact from debris, wind loads, and other trauma, than the lights on the rear of the truck, i.e., the lights facing rearwardly.

Right side 13 is generally symmetric with the left side. The right side preferably includes at least a turn signal light 18 and a brake light 19, as well as a protective enclosure or lens 24. There is also a side clearance light 17 and protective enclosure 16, side clearance light 17 facing along the general direction of the longitudinal axis A of the light bar. Central portion 12 also mounts a plurality of rear clearance lights 20. Left and right portions 11, 13 preferably also include brackets 22 with apertures 23 for mounting mud flaps. In addition, as seen best in the top view of FIG. 2, each light of the light bar is mounted in a light socket which itself is mounted to the light bar. Sockets 15 are depicted in schematic form in FIG. 2. The sockets may be permanently mounted to the light bar, or they may be removable, such as from the rear, in order to replace the lights that are placed in the sockets.

FIG. 3 depicts a rear view of the light bar with many features described above, and also including one or more connectors 25, 26, for connecting to a source of control and power for the light bar. The connectors are preferably a five-pin flat or a five-pin round connector, although other connectors may be used. Other possible connectors include a four-pin flat connector and a seven-pin round connector. More than one connector may be used because of the multiplicity of connectors used by truck manufacturers, and also because of the variety of wiring schemes. While the lighting functions remain the same, each truck manufacturer may use different colors of wires in their harnesses or connectors, or a different sequence of wires. Connecting the towing vehicle to the reusable light bar may be more quickly accomplished if more than one connector is available.

FIG. 5 illustrates a possible situation with respect to connectors 25, 26. Each connector has wires for left turn 33, right turn 35, brake 34, clearance lights 35 and ground, but the wires may be placed in a different sequence in connectors 25, 26. In this embodiment, the reusable light bar includes sockets 31 for each light that are wired in parallel with both connectors 25, 26. Ground connection 36 may include a connector for connecting to a grounding plug of the towed or towing vehicle, or other connector.

The reusable light bar may be made from a variety of materials. One embodiment uses metal, preferably aluminum, structural elements. The elements are preferably channels with a C-shaped cross section, or beams with an I-shaped cross section. The height of the web or beam is preferably about 3 inches to about 5 inches, although other sizes may be used. The depth of a channel may be about 2-3 inches, or if a structural member with a I-shaped cross section is used, the width of the flange may be about 1-2 inches (on each side). This is the preferably the maximum width for the sockets, lights, and light covers used in the light bar, since these components preferably do not extend beyond the flange or channel sides of the light bar, at least not on the side on which the lights are exposed. Keeping the lights and covering lenses within the structural shape to the extent possible helps to prevent damage during handling and transport of the light bar.

With either channels or beams, the structures may be machined or otherwise manufactured with special top and bottom flanges designed for pivoting. Alternatively, flanges may be made in the form of tabs that are welded, soldered or otherwise fastened, such as with fasteners, to the portions of the light bar. The flanges should be formed with a sufficient amount of radial symmetry, and should be able to rotate sufficiently so that they can fold. If the flanges are formed with sufficient thickness, they may be able to support the extended configuration without the need for pivot pins. For instance, in the embodiment below with ears and snap-fit connections, if the ears and arms are sufficiently thick, they will be self-supporting without pivot pins.

In addition to the rectangular and relatively square cross-sections described above and depicted in the accompanying drawings, the light bar sections may have cross sections that are round or ovate. More sizes and shapes of round or ovate cross sections are available, in both plastic and metal materials, such as steel and aluminum, and may be more economical.

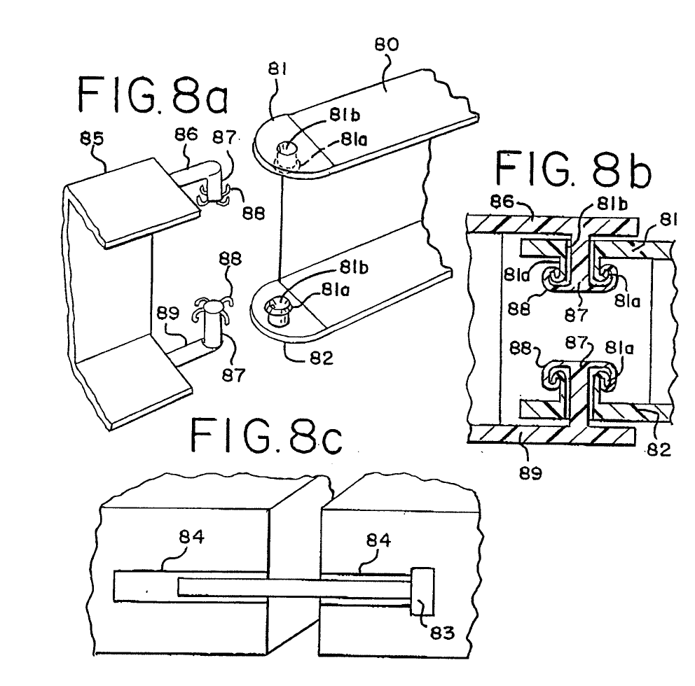

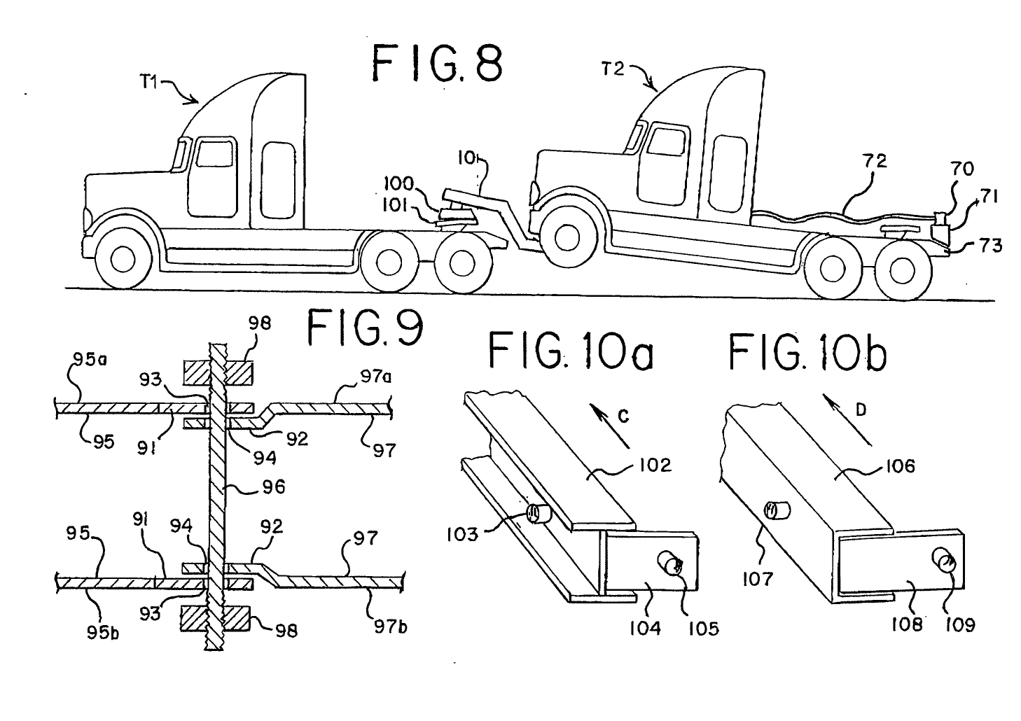

The reusable light bar may be mounted on the rear of the vehicle to be towed as depicted in FIGS. 6, 7 and 8. As seen in the side view of FIG. 6, light bar 70 in this embodiment uses an elastomeric or plastic adapter 71 to adjust the angle required for proper orientation when mounted to the rails 73 of a vehicle to be towed. The angle B formed is about 30° to about 60° to the horizontal. The adapter has a profile 71a captured in a matching slot 70a on the bottom of light bar 70. The adapter may be slightly wider than the light bar, as can be seen in top view FIG. 7. This view also depicts the light bar 70 secured to the vehicle structure 74 by clamps 75, fasteners 76 and wing nuts 77. FIG. 8 depicts the light bar 70 on the rear of a towed vehicle T2 being towed with a front tow saddle assembly 10 by a towing vehicle T1. The front tow saddle assembly 10 is mounted on a fifth wheel 101 of vehicle T1 by a kingpin (not shown) or a saddle mount 100 mounted to the towing vehicle.

In this embodiment, the light bar and profile are mounted to the vehicle, bolts or fasteners 76 secure the clamps to the vehicle structure 74, and the user tightens the light bar easily using wing nuts 77. Other fasteners or other methods may be used to secure the light bar to the vehicle. Electrical power and light control signals are passed from the towing vehicle to the light bar 70 using wiring harness 72, harness connector 78 and light bar connector 79. It will be recognized that many configurations are possible for the light bar, the adapter strip, and the hardware used to secure the light bar to the towed vehicle.

Instead of steel or aluminum, the reusable light bar may instead be molded from plastic, preferably in three parts, and then assembled. The term plastic is meant to include all thermoset and plastic materials, and also thermoset and thermoplastic materials with a reinforcement, such as carbon fibers or glass fibers. Plastic parts may also be used for components to pivot the portions and fold the light bar.

FIGS. 8a, 8b, and 8c depict plastic or reinforced plastic embodiments in which the design allows the light bar to fold. Central portion 80 includes two ears 81, 82, each with an circular aperture 81b and a male snap fit feature 81a on the periphery of the aperture. The apertures and male snap fit features are intended to mate with arms 86, 89 from a left portion 85 of the foldable light bar. Arms 86 include a transverse portion 87 and a female snap fit feature 88. To assemble the pivoting mechanism, arms 86, 89 are brought inside ears 81, 82 and the snap-fit features are mated. This assembly allows left portion 85 to rotate clock-wise with respect to central portion 80. The portions may be locked in place for use during transportation by sliding key 83 into locking channel 84, on the rear of the portions, as shown in FIG. 8c. Keys and channels may also be used on metallic versions of the light bar, and other hardware may also be used to lock the portions in place. For example, the same brackets and locking pins may be used to lock the portions in place in both the extended and folded configurations, with the appropriate spacing of mounting apertures.

Embodiments made from metal, such as steel, or preferably aluminum, also include pivoting mechanisms, of which one example is depicted in FIG. 9. In FIG. 9, extensions or ears 91 of one portion 95 of the reusable light bar are in close proximity to the ears or extensions 92 of another portion 97. The ears or extensions are preferably slightly separated in the vertical dimension, with sufficient horizontal clearance, so that the portions are able to pivot or turn without interference. The top and bottom surfaces 95a, 95b, 97a, 97b, of the remaining portions of 95, 97 preferably lie in the same planes, so that when the light bar is placed on a horizontal surface, or an adapter, the light bar will lie generally flat upon the horizontal surface or adapter. Pivot pin 96 is secured with nuts 98. Alternatively, the pivot pin may be a bolt with an affixed head that is larger than holes 93, 94, using only a single nut.

It will be recognized that the cross section of the portions of the light bar will have the general shape of an I, if an I-beam is used, or a capital C, if a channel is used. However, the left and right portions may also have an additional transverse portion to mount a side clearance light. If a small, right-angle bracket is welded to the end of the portion, then the general shape of the portion will remain largely an “I” or a “C.” It is also possible, however, to simply weld an entire plate, with the full width and height of the structural shape, onto the end of the shape. In this instance, the cross section will also be changed, but the majority portion will still have the shape of an “I” or a “C.”

FIGS. 10a and 10b illustrate these situations for the left portion of the light bar. In FIG. 10a, right portion 102 is made from a steel I-beam and has the general shape and cross section of a capital I. A right-angle bracket 104 is welded to left portion 102 and a light socket 105 is mounted to the bracket. The socket faces in the general direction of the longitudinal axis C of the left portion. Socket 103 is a socket for a turn signal and is mounted in left portion 102. Socket 103 faces transversely to the longitudinal axis of the left portion.

In FIG. 10b, right portion 106 is made from an aluminum channel and has the general shape and cross section of a capital C. Plate 108 with a rectangular shape is welded to the end of left portion 106, and a socket 109 for a side clearance light is mounted to the plate. Socket 109 faces in the general direction of the longitudinal axis D of the left portion. Socket 107 is a socket for a turn signal and is mounted in left portion 106. Socket 107 faces transversely to the longitudinal axis of the left portion.

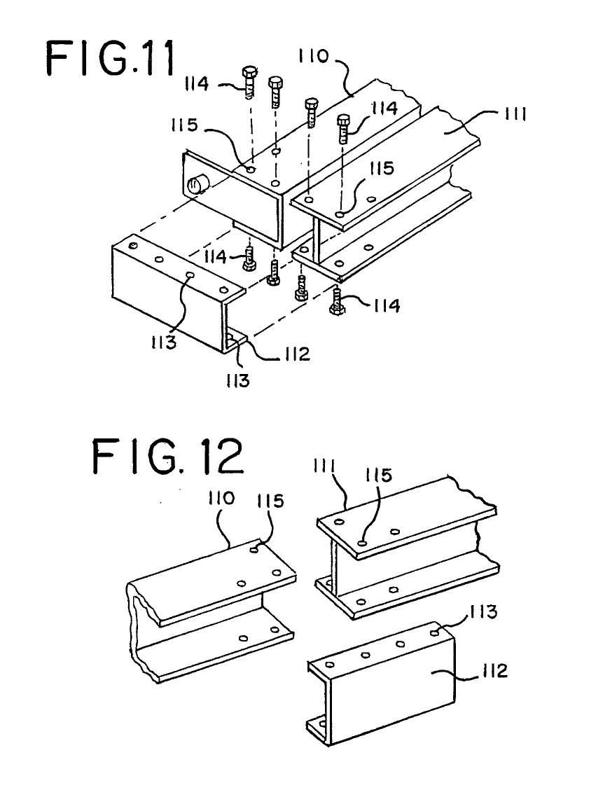

FIGS. 11-12 depict ways to secure the light bar portions in the folded configuration, FIG. 11, and in the extended configuration, FIG. 12. An end portion 110 and a middle portion 111 include apertures 115 spaced along the longitudinal axes of the portions and spaced transverse to the longitudinal axis. A bracket 112 has apertures 113 also spaced to align with the apertures 115 in the portions, in either the folded or extended configurations. The bracket is secured in either case with fasteners, such as linear spring retainers, screws, snap fits, or the bolts 114, as shown. FIGS. 11-12 also depict the folded and extended configurations for a two-part folding light bar, rather than the three-part light bar described above. While the two-part light bar cannot be folded into as compact a state as the three-part light bar, the two-part light bar will also be easy and convenient to fold and return. This also demonstrates that there are many embodiments of the folding light bar.

The embodiments described above are only a few of the many possible configurations and uses of the reusable light bar. For instance, light bars are advantageously furnished with a wiring harness and a connector for quick connection to a towing vehicle. The connector may be omitted, and instead, the ends of the wiring harness gathered together or a terminal strip furnished for connecting to the towing vehicle. The terminal strip or the gathered ends thus function as a connector, that is, to join the tow bar lights on the towed vehicle to a source of electrical power on the towing vehicle.

An elastomeric or plastic adapter strip is preferably used to adjust the vertical angle of the light bar. Instead, the light bar may use a channel or other specially-shaped structure with the desired angle on the bottom. This may be useful if the light bar itself is molded from plastic or elastomeric materials. While the light bar is described as folding by pivoting the left and right portions in a clock-wise direction, the light bar may just as easily be made to fold by pivoting the left and right portions counter-clockwise, or by pivoting the left portion in one direction and the right portion in another direction. The invention includes all these embodiments, and others as well.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A reusable light bar, comprising:
a central portion configured for mounting a first plurality of lights;
a left portion, pivotally connected to the central portion, the left portion configured for mounting a second plurality of lights;
a right portion, pivotally connected to the central potion, the right portion configured for mounting a third plurality of lights; and
at least one connector for connecting a source of electrical power to the first, second, and third pluralities of lights, wherein the reusable light bar has an extended configuration for use and a folded configuration for storage and transport.

2. The reusable light bar of claim 1, further comprising at least one bracket configured for mounting a mud flap, said bracket mounted to at least one of the left portion and the right portion.

3. The reusable light bar of claim 1, wherein the first plurality of lights comprises rear clearance lights and the second plurality and third pluralities of lights each comprise a turn signal and a brake light.

4. The reusable light bar of claim 1, wherein at least one of the left portion and the right portion further comprises a transverse mounting for a side clearance light.

5. The reusable light bar of claim 1, wherein the central portion is pivotally connected to the left and right portions by flanges and pivot pins.

6. The reusable light bar of claim 1, wherein the connector is selected from the group consisting of a five-wire flat connector and a five-wire round connector.

7. The reusable light bar of claim 1, wherein at least one of the central, left and right portions has a cross section in the shape of an I, a C, a circle, or an oval.

8. The reusable light bar of claim 1, further comprising an angled strip for mounting the light bar to a vehicle.

9. The reusable light bar of claim 1, wherein the central, left and bottom portions are molded from plastic and a bottom surface of at least one of the central, left and right portions is molded at an angle of about 30° to about 60° to a horizontal plane.

10. A reusable light bar, comprising:
a first portion comprising a first plurality of sockets, and optionally, a first plurality of lights mounted in the first plurality of sockets;
a second portion pivotally connected to the first portion, the second portion comprising a second plurality of sockets, and optionally, a second plurality of lights mounted in the second plurality of sockets;
optionally, a third portion pivotally connected to the second portion, the third portion comprising a third plurality of sockets, and a third plurality of lights mounted in the third plurality of sockets;
at least one connector mounted to one of the first and second portions; and
a wiring harness connecting the at least one connector to each socket of the first and second pluralities of sockets, and, optionally, to each socket of the third plurality of sockets.

11. The reusable light bar of claim 10, wherein a majority portion of at least one of the first and second portions comprises an aluminum structural member with a cross section in the general shape of an I or a C.

12. The reusable light bar of claim 10, further comprising at least one inner frame spacer block mounted within the first or second portions.

13. The reusable light bar of claim 10, wherein at least one of the first and second portions further comprises a side clearance light socket mounted in a direction of a longitudinal axis of the first or second portions, and further comprising a protective enclosure for a side clearance light mounted in the side clearance light socket.

14. The reusable light bar of claim 10, wherein the first and second pluralities of light sockets are mounted transversely to a longitudinal axis of the first and second portions, and further comprising a side light socket in at least one of the first and second portions, said side light socket mounted in a direction of the longitudinal axis of the first or second portions.

15. The reusable light bar of claim 10, further comprising an angled strip of rubber or plastic for mounting the light bar to a vehicle.

16. The reusable light bar of claim 10, wherein a bottom of at least one of the first or second portions is molded at an angle of about 30° to about 60° to a horizontal plane.

17. A method for using a folding light bar, the method comprising:
providing a folding light bar in a folded or an extended configuration;
if the light bar is in the folded configuration, unfolding the folding light bar and locking the folding light bar into the extended configuration;
mounting the light bar onto a rear of a towed vehicle; and
connecting the folding light bar to a source of electrical power.

18. The method of claim 17, wherein the step of mounting comprises first mounting an angled rubber or plastic mounting strip onto the rear of the towed vehicle, and then mounting the folding light bar to the mounting strip.

19. The method of claim 17, further comprising steps of:
dismounting the folding light bar;
folding the light bar into the folded configuration; and
returning the folding light bar.

20. The method of claim 17, wherein the step of unfolding the folding light bar into the extended configuration elongates the light bar about three times a folded length of the light bar.
